(19) United States
(12) Patent Application Publication
(10) Pub. No.: US 2015/0054953 A1
(43) Pub. Date: Feb. 26, 2015

(54) REAR-VIEW MIRROR FOR WINDSHIELD OF A VEHICLE

(71) Applicant: Elian Erica Frank, Herzliya (IL)

(72) Inventor: Elian Erica Frank, Herzliya (IL)

(21) Appl. No.: 14/344,408

(22) PCT Filed: Apr. 24, 2013
(86) PCT No.: PCT/IL2013/050356

§ 371 Date: Mar. 12, 2014

(30) Foreign Application Priority Data
May 7, 2012 (IL) 219631

(51) Int. Cl. B60R 1/08; B60R 1/12; B60R 1/00; B60R 1/04

(52) U.S. Cl. CPC B60R 1/082; B60R 1/04; B60R 1/12; B60R 1/00; B60R 2001/1253; B60R 2300/802
USPC 348/148; 359/872; 359/877

(57) ABSTRACT

The present invention relates to a rear-view mirror device for a windshield of a vehicle, which comprises: a) a mirror having a length that essentially extends along the entire length of said windshield, such that said mirror provides a maximize available field of view to a viewer being presence within the interior of said vehicle; b) a housing having a rear portion that is in abutting relation with the inner surface of the windshield for accommodating said mirror; and c) an adjusting mechanism adapted for adjusting the viewing angle of the mirror.

### FIELD OF THE INVENTION

The present invention relates to the field of accessories for motor vehicles. More particularly, the invention relates to mirrors for improving the visibility of objects to the sides and behind the driver of a motor vehicle.

### BACKGROUND OF THE INVENTION

To drive safely, a motor vehicle driver requires as much information as possible about other vehicles in his or her vicinity. A rear-view mirror is a mirror in automobiles and other vehicles, designed to allow the driver to see rearward through the vehicle's rear windowpane. Therefore, information about vehicles behind the driver is usually provided by glancing in an interior rear view mirror, supplemented with one or two exterior mirrors, adjusted to view “blind spots”, that is, areas not within view of the interior rear view mirror. However, consistently using several rear view mirrors can be difficult under adverse conditions, such as heavy traffic or inclement weather, when the driver's attention must be otherwise focused. The difficulty of using several rear view mirrors can become greater as a driver ages.

In typical cars, the rear-view mirror is usually affixed to the top of the vehicle's windshield on a double-swivel mount allowing it to be adjusted to suit the height and viewing angle of any driver. However, conventional interior rear view mirrors do not provide a view of the “blind spots” for which exterior mirrors are provided. One way to permit the driver to view the “blind spots” in the interior rear view mirror can be achieved by extending the width of that mirror. Unfortunately, the common double-swivel mount solution lacks the ability to effectively affixing long mirrors as an extended mirror is much heavier than a common mirror. Moreover, such common mounting solutions might be dangerous and unsafe for holding long mirror as the driver's head (or other occupant) might be hurt by the mirror.

It is an object of the present invention to provide a rear view mirror that essentially extends along the entire length of the windshield of a motor vehicle in a simple and safe manner.

It is another object of the present invention to provide rear view mirror that maximizes the fields of view and minimizes or entirely eliminates the “blind spots”.

It is yet another objective of the present invention to provide a mounting solution for relatively long rear view mirror (i.e., a mirror essentially extends along the entire length of a vehicle's windshield) which is built into the windshield of a motor vehicle.

Other objects and advantages of the invention will become apparent as the description proceeds.

### SUMMARY OF THE INVENTION

The present invention relates to a rear-view mirror device for windshield of a vehicle, which comprises: a) a housing that is in abutting relation with the inner face of the windshield; b) a mirror accommodated within said housing; and c) adjusting mechanism for adjusting the viewing angle of the mirror.

In another aspect the present invention relates to a rear-view mirror device for a windshield of a vehicle, which comprises:
a. a mirror having a length that essentially extends along the entire length of said windshield, such that said mirror provides a maximize available field of view to a viewer being presence within the interior of said vehicle;
b. a housing having a rear portion that is in abutting relation with the inner surface of the windshield for accommodating said mirror; and
c. an adjusting mechanism adapted for adjusting the viewing angle of the mirror.

According to an embodiment of the invention, the adjusting mechanism is an electronic or electro-mechanic based adjustment mechanism, thereby allowing to electronically and/or automatically adjusting the viewing angle of the mirror.

According to an embodiment of the invention, the rear-view mirror device further comprises a mounting and/or securement system for attaching the housing to the inner surface of the windshield.

In one aspect, the length of the mirror is essentially equal to the length of the windshield. In another aspect, the length of the mirror is at least half the length of the windshield. For maximal field of view the device should utilize the entire length of the windshield (i.e., almost the same length as the windshield).

According to an embodiment of the invention, the rear portion is inclined and/or having a curved shape in order to fit the position and form of the interior surface of the windshield.

According to an embodiment of the invention, the rear-view mirror further comprises one or more electronic modules for communicating with one or more peripheral devices either in a wired or wireless manner. The rear-view mirror device may further comprise a screen for displaying data received from the one or more peripheral devices. The peripheral devices are selected from the group consisting of: a mobile device, an image capturing device, a reverse camera system or any other sensor or electronic device adapted to apply information that might be relevant to the driver and/or passenger(s) of the vehicle, such as at least one image capturing device and a corresponding electronic circuitry for display images captured by said image capturing device, either in real-time or not (e.g., Digital Video Reordering system for cars).

### BRIEF DESCRIPTION OF THE DRAWINGS

In the drawings:

FIG. 1 schematically illustrates a rear view mirror device, according to an embodiment of the invention;

FIG. 2 schematically illustrates the housing of the device of FIG. 1; and

FIG. 3 schematically illustrates the rear view mirror integrated with the front windshield of a car, according to an embodiment of the present invention.

### DETAILED DESCRIPTION OF THE INVENTION

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Throughout this description the term “windshield” is used to indicate an essentially transparent front windowpane of an automotive vehicle. This term does not imply any particular shape, construction material or geometry, and invention is applicable to all suitable windowpanes.

The terms, “for example”, “e.g.”, “optionally”, as used herein, are intended to be used to introduce non-limiting examples. While certain references are made to certain example system components, other components can be used as well and/or the example components can be combined into fewer components and/or divided into further components.

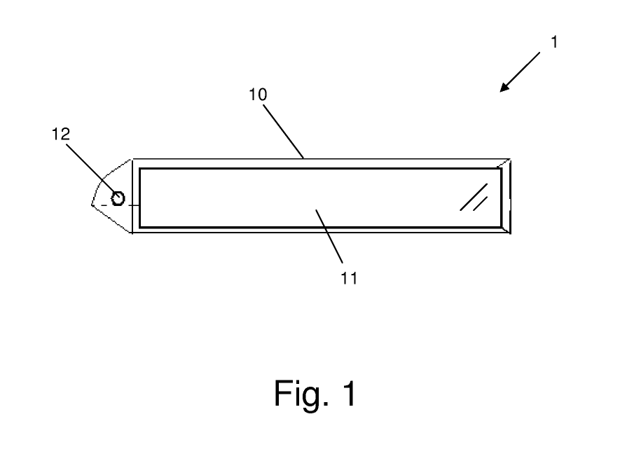

FIG. 1 shows a rear view mirror device that can be used in conjunction with the invention. The rear view mirror device is adapted for attachment to a portion of an existing automotive vehicle and particularly in the passenger compartment of an automotive vehicle. The device illustrated in this figure is particularly convenient because it can be applied as an add-on device to existing windshield without the need to carry out any alterations to the interior of the automotive vehicle. The device generally indicated by numeral 1 in the figure comprises a mirror 11 and an outer housing 10 that is in abutting relation with the inner surface of the windshield for accommodating the mirror 11.

The device 1 may further comprise an adjusting mechanism 12 to fit viewing with mirror 11 to different drivers (e.g., a shaft or an axis upon/around which the viewing angle of the mirror 11 can be changed manually). Alternatively, the adjusting mechanism is an electronic mirror adjusting mechanism similar to common side mirror electronic adjustment mechanism, which usually includes a DC motor and an adjustment switch. Such electronic mechanism is used for electronically adjust the position of the mirror in order to change its viewing angle.

The rear view mirror device 1 of the present invention is a wide viewing angle mirror device (i.e., due to its extended width) such that it provides the viewer with a maximize field of view that is possible from within the passenger compartment of the vehicle. The device 1 is adapted for use in essentially all types of automotive vehicles, which includes trucks, passenger vehicles, boats, airplanes, and the like.

The rear view mirror device of the present invention differs from prior-art mirror devices in that this present mirror device is a relatively long mirror device that can be integrated or can be attached to the upper portion of the windshield, essentially along the entire length of the windshield. In contradiction to the prior-art mounting solutions (e.g., the double-swivel mount in which the rear-view mirror is usually hanged from the windshield), the rear view mirror device of the present invention is in abutting relation with inner surface of the windshield. Moreover, such configuration provides also a safe and esthetic solution with respect to the prior-art mounting solutions. In this way, the mirror device of the present invention enables a relatively wide-angled view of the rear and the sides of the automotive vehicle, when in use. Thus, due to the substantial length of the present device, the suggested arrangement provides an efficient solution to rigidly hold the mirror device in an affixed position within the passenger compartment of the vehicle.

The present invention provides a means of attachment which is effectively used for securing the rear view mirror device in a fixed position within the automotive vehicle. These means of attachment are uniquely adapted to be attached (or in some case even integrated) to the windshield. The adjustment mechanism 12 provides the required degree of adjustability to accommodate easy viewing by any sized operator of the vehicle. For example, in this way, the rear view mirror device can be mounted for pivotal movement.

According to an embodiment of the invention, the outer housing 10 is curved in shape in order to fit the interior surface of a vehicle's windshield. In such case, housing 10 is having an essentially curved rear portion for attaching the device 1 to the interior surface of the windshield.

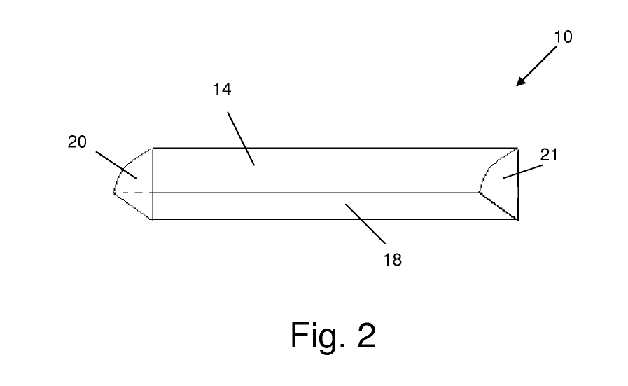

According to an embodiment of the invention, housing 10 comprises an essentially inclined rear portion 14 and a bottom portion 18 which are connected by spaced apart end walls 20 and 21. In this way, the housing 10 forms an enclosing outer section with an interior compartment 22, in the manner as illustrated in FIGS. 1 and 2 of the drawings. The inclination of the rear portion 14 depends on the corresponding form and position of the vehicle's windshield.

The housing 10 can be formed of any suitable material, as for example, plastics and reinforced plastics which are formed by suitable molding techniques, metals, polymers or any other suitable rigid material. Thus, the housing 10 is formed of a polyvinyl material, although they may be formed of polyethylene, polystyrene, etc. The housing 10 could also be formed of various metals and other structural materials which can be adhered to or integrated within the windshield.

According to an embodiment of the invention, the rear view mirror device 1 comprises a mounting and/or securement system which includes attachment means located at the surface of the rear portion 14 of the housing 10. For example, the attachment means can be any adhered material suitable to be attached to the inner surface of the windshield, such as Gunther Ultra/Bond Mirror Mastic or other adhesive formulated adapted to provide a strong, permanent bond between various substrates.

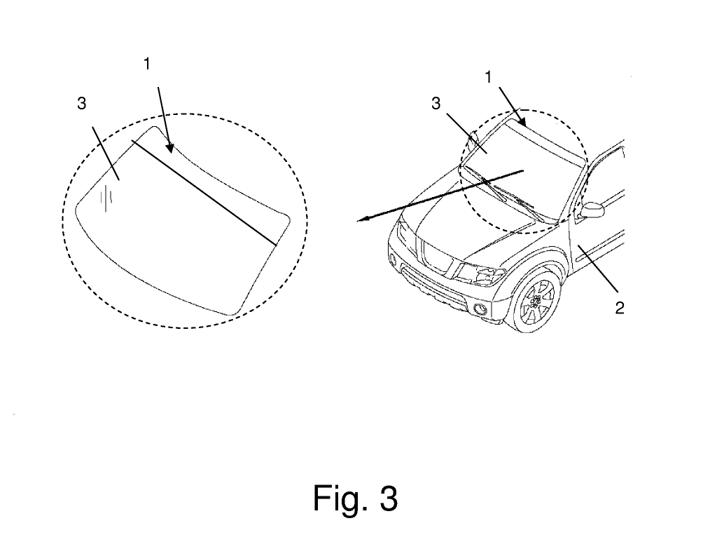

According to an embodiment of the present invention, the rear view mirror device 1 can be manufactured as an integral part of the car's windshield, e.g., by using industrial adhesion techniques and/or materials such as industrial adhesive bonders by DYMAX Corporation (e.g., DYMAX Light-Weld® UV curable glass bond assembly which adhesives cure in seconds upon exposure to ultraviolet light. Multi-Cure® grades cure with UV light, activator, or heat for UV blocked and tinted glass). FIG. 3 schematically illustrates the rear view mirror 1 integrated with the front windshield 3 of a car 2, according to an embodiment of the present invention.

According to an embodiment of the present invention, the device further comprises one or more electronic circuitry for communicating with peripheral devices and a screen for displaying information received from such peripheral devices (not shown). For example, such peripheral devices may include a mobile device (e.g., a smartphone or other cellular telephone), at least one image capturing device (e.g., a reverse or backup camera system that is produced specifically for the purpose of being attached to the rear of a vehicle to aid in backing up).

Thus, there has been illustrated and described a unique and novel rear view mirror device for automotive vehicles which is provided with a unique mounting system and which is capable of being manufactured and assembled easily and at a relatively low cost. Thus, the present invention fulfills all of the objects and advantages which have been sought. It should be understood that many changes, modifications, variations, and other uses and applications will become apparent to those skilled in the art drawings after considering this invention. Therefore, any and all such changes, modifications, variations, and other uses and applications which do not depart from the spirit and scope of the invention are deemed to be covered by the invention which is limited only by the following claims.

All the above description and examples have been given for the purpose of illustration and are not intended to limit the invention in any way. Many different mechanisms, methods of analysis, electronic and logical elements can be employed, all without exceeding the scope of the invention.

1. A rear-view mirror device for a windshield of a vehicle, comprising:
a) a mirror having a length that essentially extends along the entire length of said windshield, such that said mirror provides a maximize available field of view to a viewer being presence within the interior of said vehicle;
b) a housing having a rear portion that is in abutting relation with the inner surface of the windshield for accommodating said mirror, wherein said housing is adapted to fit the position and form of the interior surface of the windshield; and
c) an adjusting mechanism adapted for adjusting the viewing angle of the mirror.

2) A rear-view mirror device according to claim 1, in which the adjusting mechanism is an electronic based adjustment mechanism, thereby allowing to electronically and/or automatically adjusting the viewing angle of the mirror.

3) A rear-view mirror device according to claim 1, further comprising a mounting and/or securement system for attaching the housing to the inner surface of the windshield.

4) A rear-view mirror device according to claim 1, in which the length of the mirror is essentially equal to the length of the windshield.

5) A rear-view mirror device according to claim 1, in which the length of the mirror is at least half the length of the windshield.

6) A rear-view mirror device according to claim 1, in which the rear portion is inclined and/or having a curved shape in order to fit the position and form of the interior surface of the windshield.

7) A rear-view mirror device according to claim 1, further comprises one or more electronic modules for communicating with one or more peripheral devices in a wired or wireless manner.

8) A rear-view mirror device according to claim 7, further comprises a screen for displaying data received from the one or more peripheral devices.

9) A rear-view mirror device according to claim 7, in which the peripheral devices are selected from the group consisting of: a mobile device, an image capturing device and a reverse camera system.

10) A rear-view mirror device according to claim 1, further comprises at least one image capturing device and a corresponding electronic circuitry for display images captured by said image capturing device, either in real-time or not.
